(19) United States
(12) Patent Application Publication
(10) Pub. No.: US 2026/0072716 A1
(43) Pub. Date: Mar. 12, 2026

(54) VIRTUAL SENSOR PERFORMANCE MONITORING DEVICE AND METHOD

(71) Applicant: Electronics and Telecommunications Research Institute, Daejeon (KR)

(72) Inventors: Hak Jong SHIN, Daejeon (KR); Hyeon PARK, Daejeon (KR); Jae Young JUNG, Daejeon (KR); Seng Kyoun JO, Daejeon (KR)

(21) Appl. No.: 19/326,583

(22) Filed: Sep. 11, 2025

(30) Foreign Application Priority Data
Sep. 11, 2024 (KR) 10-2024-0124264

(51) Int. Cl. G06F 9/455; G06F 11/34; G06Q 50/02

(52) U.S. Cl. CPC G06F 9/455; G06F 11/3409; G06Q 50/02

(57) ABSTRACT

The present invention relates to a virtual sensor performance monitoring device. The device includes a sensor, and a processor configured to monitor performance of a virtual sensor that predicts an amount of dissolved oxygen in an aquaculture farm on the basis of aquaculture farm environment data collected through the sensor.

### CROSS-REFERENCE TO RELATED APPLICATION

This application claims priority to and the benefit of Korean Patent Application No. 10-2024-0124264, filed on September 11, 2024, the disclosure of which is incorporated herein by reference in its entirety.

### BACKGROUND

### Field of the Invention

The present invention relates to a virtual sensor performance monitoring device and method.

### Discussion of Related Art

In aquaculture farms, appropriate management of the amount of dissolved oxygen is essential for fish survival and growth. In particular, in flow-through aquaculture farms, because water flows continuously, it is important to accurately monitor and adjust oxygen concentration in water. Currently, conventional sensors for measuring an amount of dissolved oxygen have high installation costs, complex maintenance, and the problem of difficulty in responding rapidly when the sensors fail or errors occur. Further, due to limitations in real-time data, the operational efficiency of aquaculture farms may be reduced.

In order to address these problems, a virtual sensor technology is being focused on. The virtual sensor technology is a technology for predicting required data using algorithms on the basis of data measured by actual sensors. Virtual sensors are more cost-effective and easier to maintain than conventional sensors. However, the performance of virtual sensors depends highly on the accuracy of the models used, and the models may need to be updated as an aquaculture farm environment changes.

### SUMMARY OF THE INVENTION

The present invention is directed to providing a virtual sensor performance monitoring device and method capable of accurately predicting an amount of dissolved oxygen in a flow-through aquaculture farm water tank by updating a virtual sensor to match a flow-through aquaculture farm environment.

According to an aspect of the present invention, there is provided a virtual sensor performance monitoring device which includes a sensor, and a processor configured to monitor performance of a virtual sensor that predicts an amount of dissolved oxygen in an aquaculture farm on the basis of aquaculture farm environment data collected through the sensor.

The processor may monitor the performance of the virtual sensor using an anomaly detection model of the virtual sensor.

The anomaly detection model may use the aquaculture farm environment data to predict the amount of dissolved oxygen in the aquaculture farm.

The processor may monitor the performance of the virtual sensor on the basis of a predicted value of the amount of dissolved oxygen.

The processor may update the virtual sensor on the basis of a result of monitoring the performance of the virtual sensor.

The processor may compare a predicted value of the amount of dissolved oxygen with an actual value to calculate a residual between the predicted value and the actual value, and when the residual exceeds a preset threshold value, updates the virtual sensor.

The anomaly detection model may obtain the predicted value of the amount of dissolved oxygen using an artificial neural network based on an autoencoder that uses the aquaculture farm environment data as an input.

When the input data is compressed into a low-dimensional feature space through the autoencoder and then restored to the same dimension as original data to generate restored data, the processor may calculate the residual on the basis of a similarity between the restored data and the original data, and when the residual exceeds the threshold value, update the virtual sensor.

The aquaculture farm environment data may include at least one piece of data among a water temperature of a water tank, pH, a seawater temperature, a tidal change, and a water intake pump flow rate.

The virtual sensor is a model of an artificial neural network structure including an input layer that receives the aquaculture farm environment data as input data, at least one hidden layer, and an output layer that outputs a result, and may adjust a weight of each layer through a training process to predict the amount of dissolved oxygen from the input data.

According to another aspect of the present invention, there is provided a virtual sensor performance monitoring method which includes collecting, by a processor, aquaculture farm environment data through a sensor, and monitoring, by the processor, performance of a virtual sensor that predicts an amount of dissolved oxygen in an aquaculture farm on the basis of the collected aquaculture farm environment data.

The monitoring of the performance of the virtual sensor may include monitoring the performance of the virtual sensor using an anomaly detection model of the virtual sensor.

The anomaly detection model may use the aquaculture farm environment data to predict the amount of dissolved oxygen in the aquaculture farm.

The monitoring of the performance of the virtual sensor may include monitoring the performance of the virtual sensor on the basis of a predicted value of the amount of dissolved oxygen.

The virtual sensor performance monitoring method may further include updating, by the processor, the virtual sensor on the basis of a result of monitoring the performance of the virtual sensor.

The updating of the virtual sensor may include comparing a predicted value of the amount of dissolved oxygen with an actual value and calculating a residual between the predicted value and the actual value, and when the residual exceeds a preset threshold value, updating the virtual sensor.

The anomaly detection model may obtain the predicted value of the amount of dissolved oxygen using an artificial neural network based on an autoencoder that uses the aquaculture farm environment data as an input.

The updating of the virtual sensor may include, when the input data is compressed into a low-dimensional feature space through the autoencoder and then restored to the same dimension as original data to generate restored data, calculating the residual on the basis of a similarity between the restored data and the original data, and when the residual exceeds the threshold value, updating the virtual sensor.

The aquaculture farm environment data may include at least one piece of data among a water temperature of a water tank, pH, a seawater temperature, a tidal change, and a water intake pump flow rate.

The virtual sensor is a model of an artificial neural network structure including an input layer that receives the aquaculture farm environment data as input data, at least one hidden layer, and an output layer that outputs a result, and may adjust a weight of each layer through a training process to predict the amount of dissolved oxygen from the input data.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a network configuration of a virtual sensor performance monitoring device according to an embodiment of the present invention;

FIG. 2 is a block diagram for describing a detailed configuration of the virtual sensor performance monitoring device of FIG. 1;

FIG. 3 is a diagram illustrating the arrangement of sensors in a flow-through aquaculture farm according to an embodiment of the present invention;

FIG. 4 is a diagram illustrating a model structure of a virtual sensor according to an embodiment of the present invention;

FIG. 5 is a diagram for describing an anomaly detection model of a virtual sensor according to an embodiment of the present invention; and

FIG. 6 is a flowchart for describing a virtual sensor performance monitoring method according to an embodiment of the present invention.

### DETAILED DESCRIPTION OF EXEMPLARY EMBODIMENTS

Hereinafter, embodiments of the present invention will be described. In this process, thicknesses of lines, sizes of components, and the like illustrated in the drawings may be exaggerated for clarity and convenience of description. Further, some terms which will be described below are defined in consideration of functions in the present invention and meanings may vary depending on, for example, a user or operator’s intentions or customs. Therefore, the meanings of these terms should be interpreted based on the scope throughout this specification.

Hereinafter, embodiments of the present invention that can be easily performed by those skilled in the art will be described in detail with reference to the accompanying drawings. However, embodiments of the present invention may be implemented in several different forms and are not limited to embodiments described herein. In addition, parts irrelevant to description are omitted in the drawings in order to clearly explain the present invention. Similar parts are denoted by similar reference numerals throughout this specification.

Throughout this specification, when a certain part “includes” a certain component, this does not exclude other components from being included unless described otherwise, and other components may in fact be included.

The implementations described herein may be conducted, for example, as a method or process, a device, a software program, a data stream, or signals. Even when discussed only in the context of a single form of implementation (e.g., discussed only as a method), the implementation of the features discussed may also be conducted in other forms (e.g., as a device or a program). A device may be implemented as appropriate hardware, software, firmware, etc. A method may be implemented in a device, such as a processor, which generally refers to a processing device including, for example, a computer, a microprocessor, an integrated circuit, a programmable logic device, or the like.

Hereinafter, embodiments of the present invention will be described in detail with reference to the accompanying drawings.

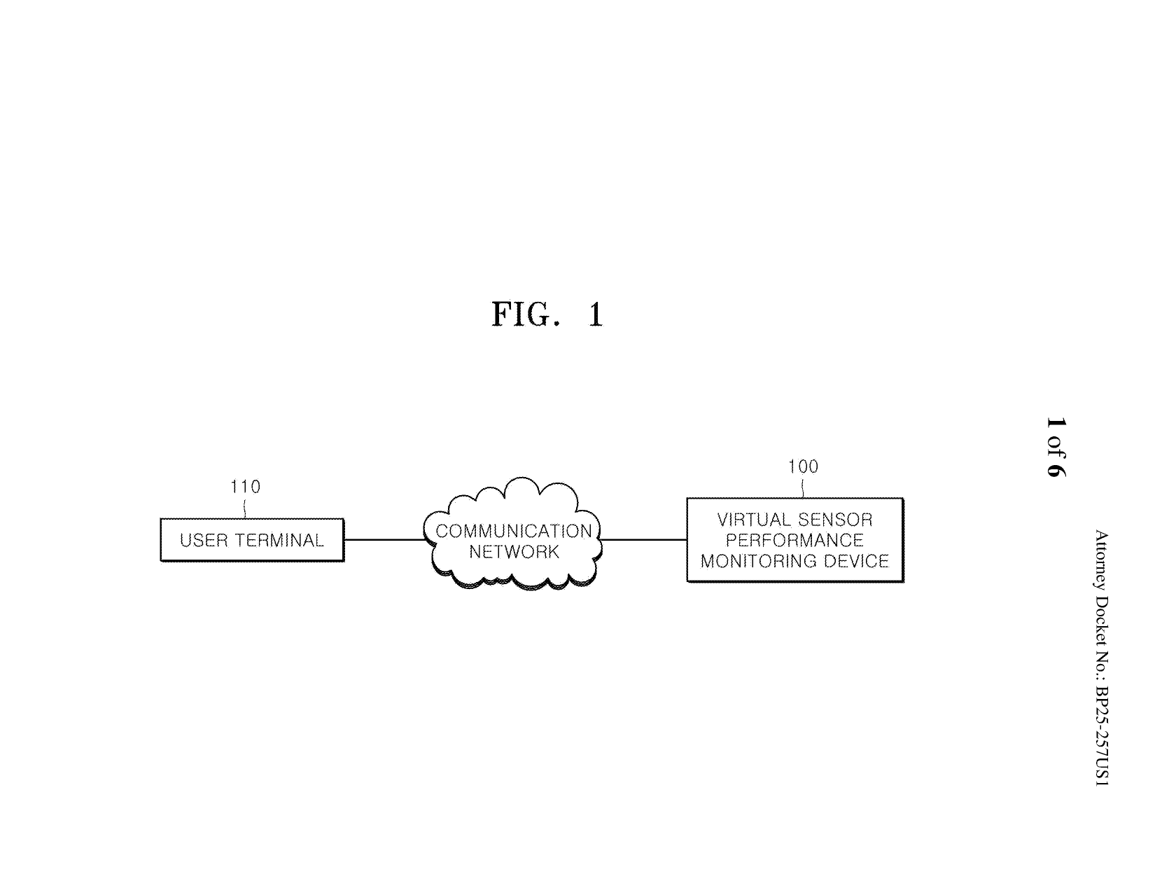

FIG. 1 is a diagram illustrating a network configuration of a virtual sensor performance monitoring device according to an embodiment of the present invention.

Referring to FIG. 1, a virtual sensor performance monitoring device 100 according to the embodiment of the present invention may continuously collect aquaculture farm environment data in a flow-through aquaculture farm and integrate and process the continuously collected aquaculture farm environment data. The virtual sensor performance monitoring device 100 may support the operation of a virtual sensor, which predicts an amount of dissolved oxygen on the basis of the aquaculture farm environment data, and the operation of an anomaly detection model. Accordingly, an aquaculture farm manager may monitor data related to the performance of the virtual sensor in real time through a user terminal 110.

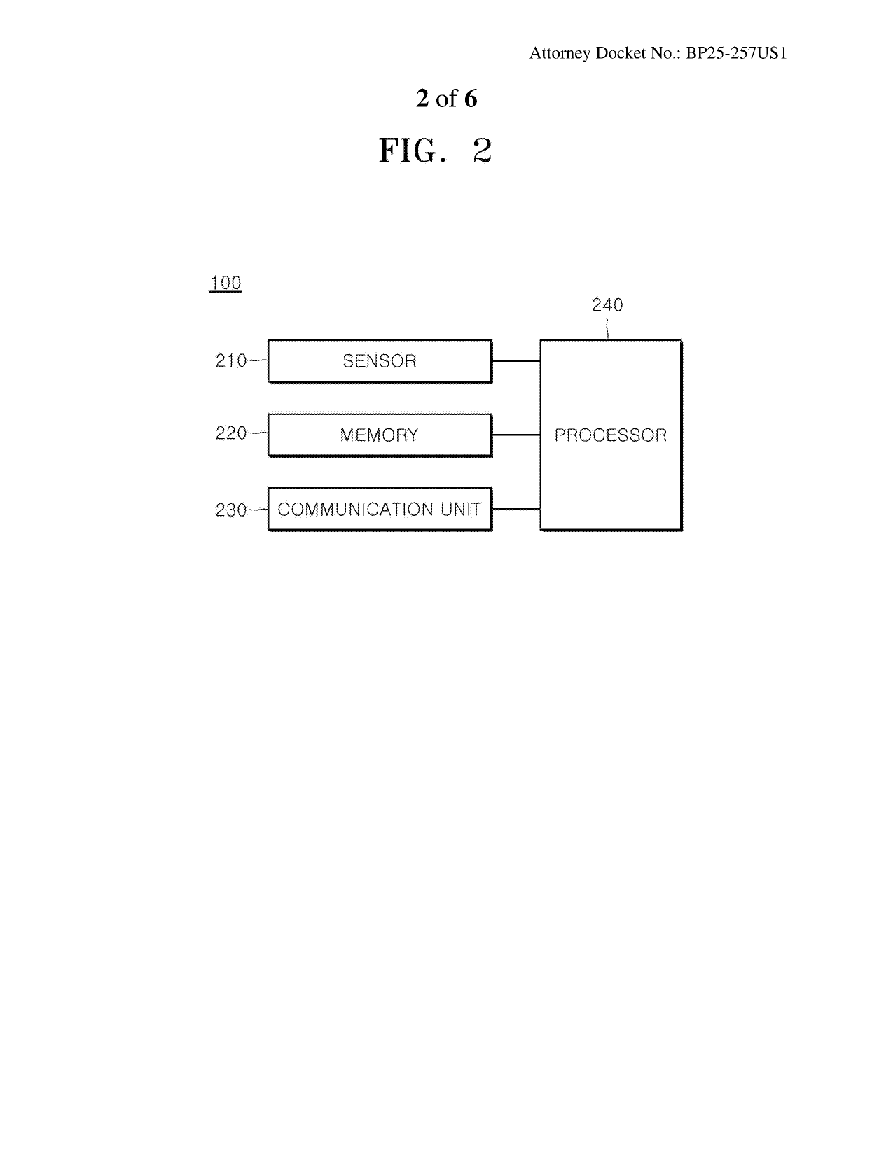

FIG. 2 is a block diagram for describing a detailed configuration of the virtual sensor performance monitoring device 100 of FIG. 1.

Referring to FIGS. 1 and 2, the virtual sensor performance monitoring device 100 according to the embodiment of the present invention may include sensors 210, a memory 220, a communication unit 230, and a processor 240.

The sensors 210 may be installed in the flow-through aquaculture farm to measure the aquaculture farm environment data and continuously collect the measured aquaculture farm environment data. Here, the aquaculture farm environment data may include at least one piece of data among a water temperature of a water tank, a pH, a seawater temperature, a tidal change, and a water intake pump flow rate.

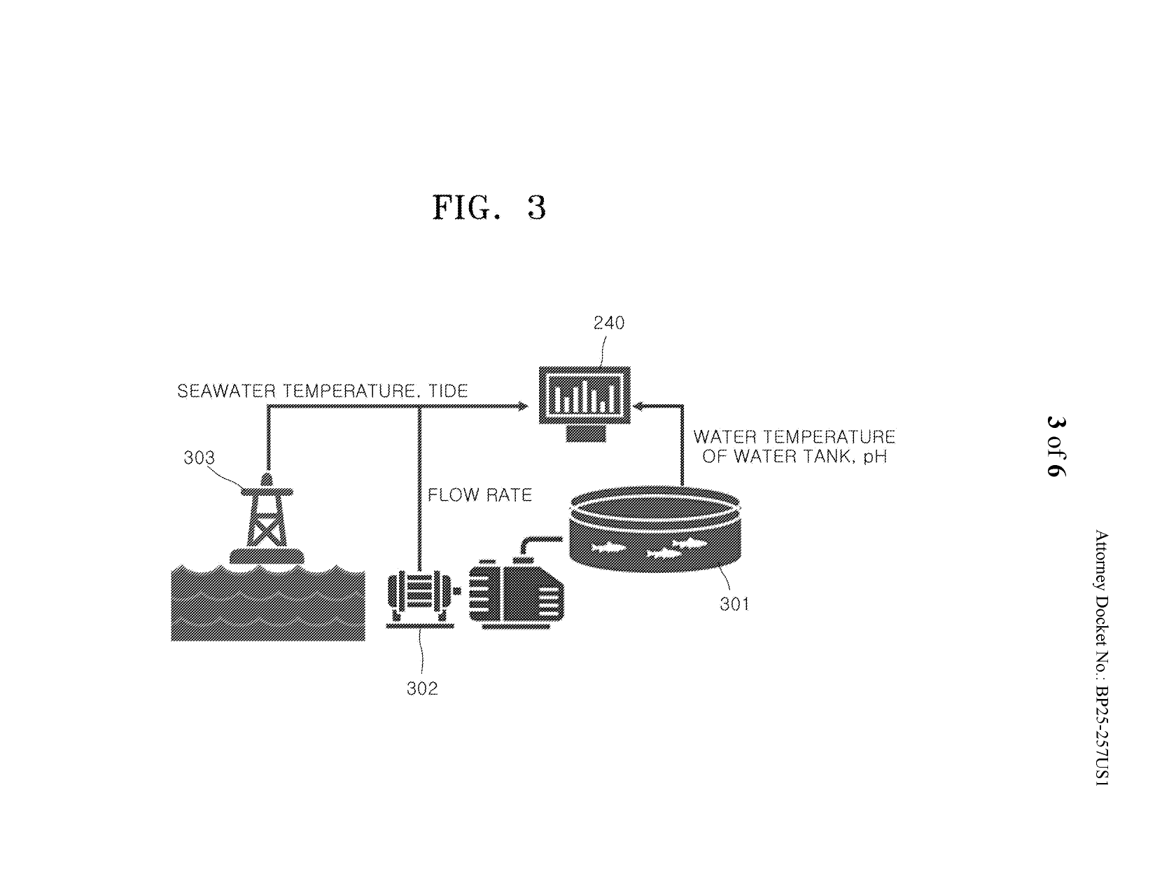

To this end, the sensors 210 may each be placed in a water tank 301, a water intake pump 302, an ocean observation buoy 303, and the like of the flow-through aquaculture farm, as illustrated in FIG. 3. For reference, FIG. 3 is a diagram illustrating the arrangement of sensors in a flow-through aquaculture farm according to an embodiment of the present invention and visually illustrates the locations and functions of the respective sensors that measure a water temperature of a water tank, a pH, a seawater temperature, a tidal change, and a water intake pump flow rate.

That is, a sensor 210 that measures the water temperature of the water tank and the pH may be placed in each water tank 301 of the flow-through aquaculture farm, and a sensor 210 that measures the seawater temperature and the tidal change may be installed on the ocean observation buoy 303. Further, a sensor 210 that measures the water intake pump flow rate may be directly attached to the water intake pump 302. The sensor 210 that measures the water intake pump flow rate may precisely measure the operating efficiency of the water intake pump and an amount of water introduced into the water tank.

In this way, data measured by each sensor 210, that is, aquaculture farm environment data, may be transmitted to a central processing unit (CPU), which is an example of the processor 240, and used for real-time monitoring and analysis. In this case, the aquaculture farm environment data may be directly transmitted to the CPU, or alternatively, may be stored in the memory 220 and then transmitted to the CPU as needed.

The memory 220 may store at least one instruction executed by the processor 240. The memory 220 may be implemented as an internal memory, such as a read-only memory (ROM) (e.g., an electrically erasable programmable ROM (EEPROM)), a random access memory (RAM), or the like, included in the processor 240, or may be implemented as a separate memory from the processor 240.

In this case, the memory 220 may be implemented in the form of a memory embedded in the virtual sensor performance monitoring device 100 or in the form of a memory that is detachable from the virtual sensor performance monitoring device 100 according to the purpose of data storage.

For example, data for driving the virtual sensor performance monitoring device 100 may be stored in a memory 220 embedded in the virtual sensor performance monitoring device 100, and data for an expanded function of the virtual sensor performance monitoring device 100 may be stored in a memory 220 that is detachable from the virtual sensor performance monitoring device 100.

Here, the memory 220 embedded in the virtual sensor performance monitoring device 100 may be implemented as at least one of a volatile memory (e.g., a dynamic RAM (DRAM), a static RAM (SRAM), a synchronous dynamic RAM (SDRAM), or the like), and a non-volatile memory (e.g., a one time programmable ROM (OTPROM), a programmable ROM (PROM), an erasable and programmable ROM (EPROM), an EEPROM, a mask ROM, a flash ROM, a flash memory (e.g., a NAND flash memory, a NOR flash memory, or the like), a hard drive, or a solid state drive (SSD)).

Further, the memory 220 that is detachable from the virtual sensor performance monitoring device 100 may be implemented in the form of a memory card (e.g., a compact flash (CF) card, a secure digital (SD) card, a micro-SD card, a mini-SD card, an extreme digital (xD) card, a multi-media card (MMC), or the like), an external memory (e.g., a Universal Serial Bus (USB) memory) that is connectable to a USB port, or the like.

The communication unit 230 may perform wired or wireless communication with other devices or networks. To this end, the communication unit 230 may include a communication module that supports at least one of various wired or wireless communication methods. For example, the communication module may be implemented in the form of a chipset.

Wireless communications supported by the communication unit 230 may include, for example, Wireless Fidelity (Wi-Fi), Wi-Fi Direct, Bluetooth, Ultra-wide band (UWB), near-field communication (NFC), etc. Further, wired communications supported by the communication unit 230 may include, for example, USB, High-Definition Multimedia Interface (HDMI), etc.

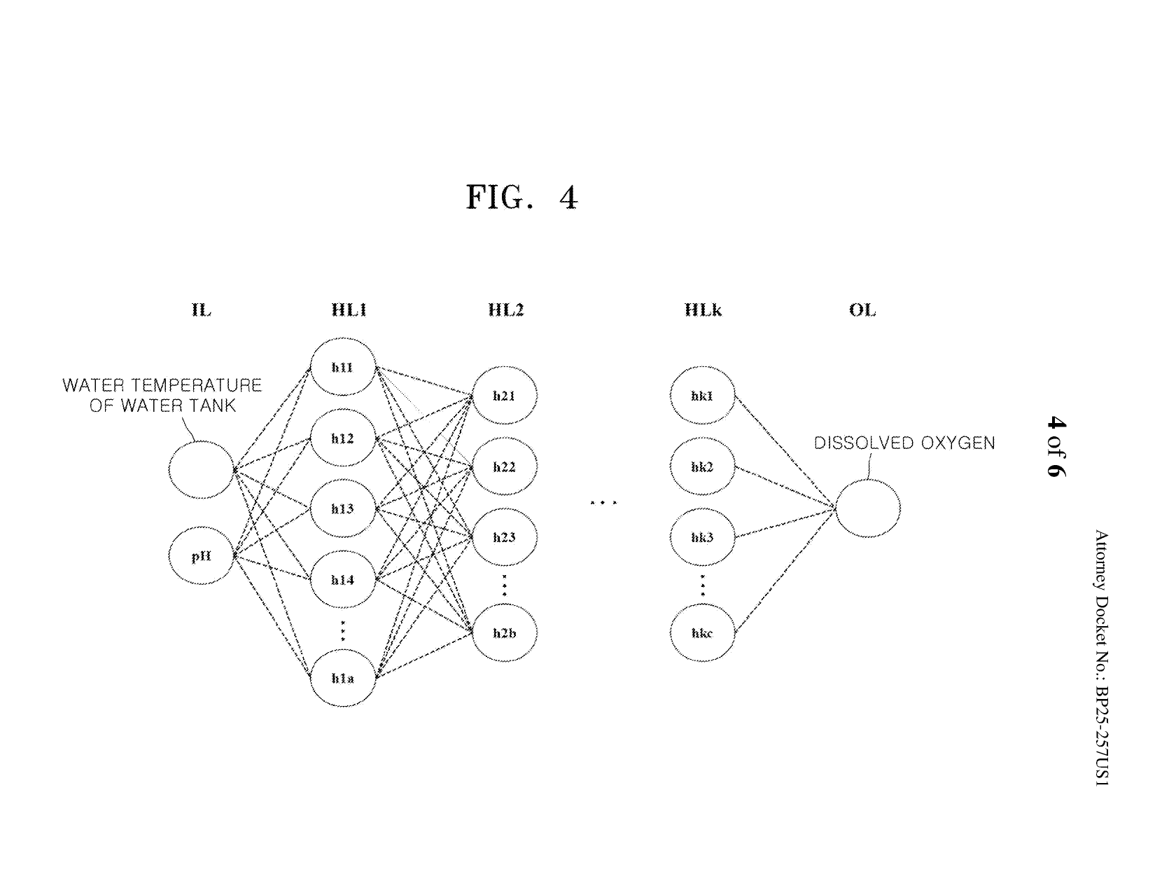

The processor 240 may monitor the performance of a virtual sensor that predicts an amount of dissolved oxygen in an aquaculture farm on the basis of the aquaculture farm environment data collected through the sensors 210. Here, the virtual sensor is a model of an artificial neural network (ANN) structure including an input layer that receives the aquaculture farm environment data as input data, at least one hidden layer, and an output layer that outputs a result, and the virtual sensor may adjust a weight of each layer through a training process to predict the amount of dissolved oxygen from the input data. This will be described in detail with reference to FIG. 4.

To this end, the processor 240 may monitor the performance of the virtual sensor using an anomaly detection model of the virtual sensor. That is, the anomaly detection model uses the aquaculture farm environment data to predict the amount of dissolved oxygen in the aquaculture farm, and the processor 240 may monitor the performance of the virtual sensor on the basis of a predicted value of the amount of dissolved oxygen.

The processor 240 may update the virtual sensor on the basis of a result of monitoring the performance of the virtual sensor. To this end, the processor 240 may compare the predicted value of the amount of dissolved oxygen with an actual value. The processor 240 may calculate a residual between the predicted value of the amount of dissolved oxygen and the actual value according to a result of the comparison.

The processor 240 may compare the calculated residual with a preset threshold value. As a result of the comparison, when the residual between the predicted value of the amount of dissolved oxygen and the actual value exceeds the preset threshold value, the processor 240 may update the virtual sensor.

In other words, when the residual between the predicted value of the amount of dissolved oxygen and the actual value exceeds the preset threshold value, the processor 240 may determine that an environment of the flow-through aquaculture farm has changed, and may update the virtual sensor to minimize sensing errors of the virtual sensor that are caused by the change of the environment.

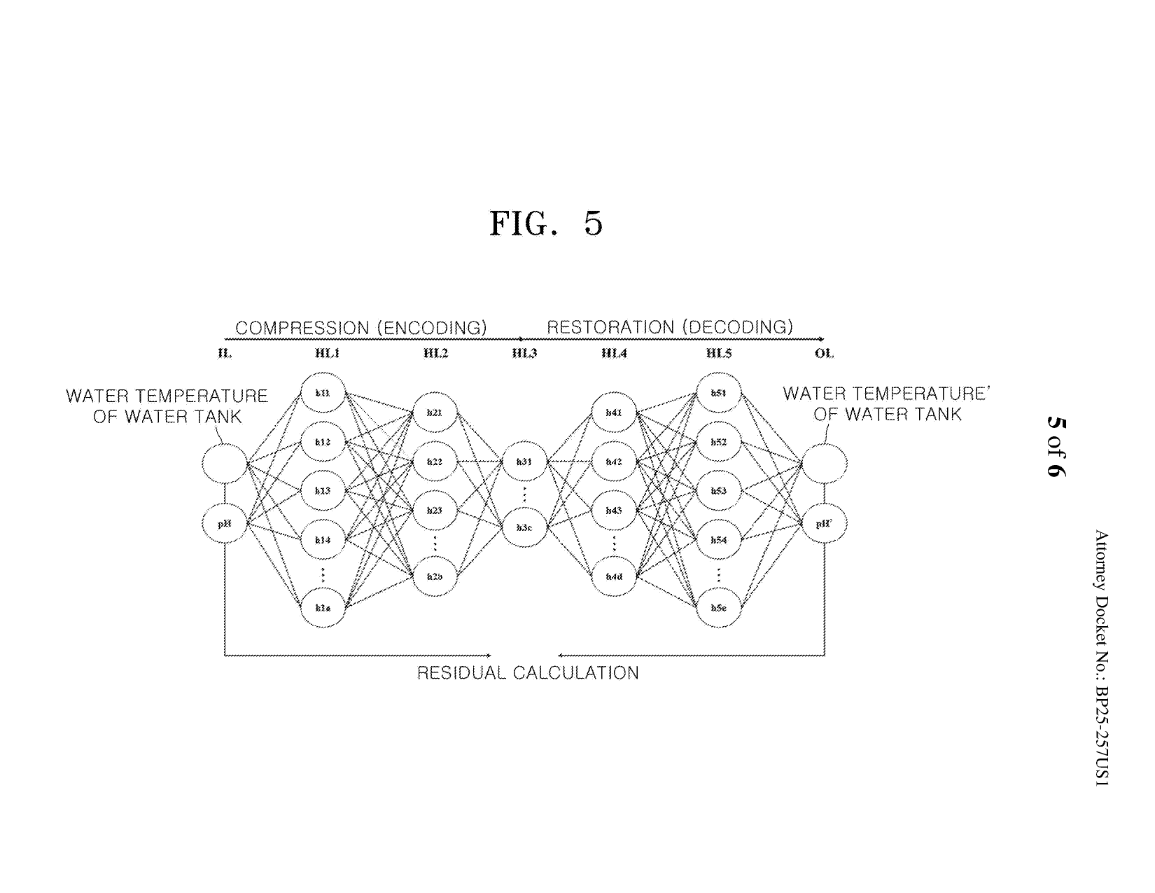

Here, the anomaly detection model may obtain the predicted value of the amount of dissolved oxygen using an ANN based on an autoencoder that uses the aquaculture farm environment data as an input. This will be described in detail with reference to FIG. 5.

Accordingly, when the input data is compressed into a low-dimensional feature space through the autoencoder and then restored to the same dimension as original data to generate restored data, the processor 240 may calculate the residual on the basis of a similarity between the restored data and the original data, and when the calculated residual exceeds the threshold value, update the virtual sensor.

FIG. 4 is a diagram illustrating a model structure of a virtual sensor according to an embodiment of the present invention.

Referring to FIG. 4, the virtual sensor may include an algorithm for analyzing data (aquaculture farm environment data) collected from the sensor 210 (see FIG. 2) to predict an amount of dissolved oxygen. The virtual sensor may utilize machine learning technology to learn patterns in the collected data, thereby continuously improving prediction accuracy. Through this systematic data processing and learning process, the virtual sensor may more accurately predict changes in an amount of dissolved oxygen in the aquaculture farm.

The virtual sensor is based on an ANN structure with various layers. This structure may consist of an input layer IL that receives input data, one or more hidden layers HL, and an output layer OL that outputs a result. Each layer IL, HL, or OL plays an important role in extracting and transforming features from data.

Through the learning process, the virtual sensor may be optimized to effectively predict an amount of dissolved oxygen from the input data (aquaculture farm environment data) by adjusting weights of these layers IL, HL, and OL. As input variables for the virtual sensor, excluding data of sensors obtained by directly measuring the amount of dissolved oxygen, the aquaculture farm environment data, including a water temperature of a water tank, a pH value, etc., which are environmental factors of the flow-through aquaculture farm, may be utilized.

Such aquaculture farm environment data plays an important factor in predicting changes in an amount of dissolved oxygen, and the virtual sensor integrates this information to enable more precise predictions of dissolved oxygen. This process allows the aquaculture farm manager to make appropriate adjustments based on real-time data analysis, thereby optimizing an aquaculture environment.

FIG. 5 is a diagram for describing an anomaly detection model of a virtual sensor according to an embodiment of the present invention.

Referring to FIG. 5, the anomaly detection model functions to evaluate the accuracy of the virtual sensor by analyzing a difference between a predicted value of an amount of dissolved oxygen and an actual value (measured value) and to automatically trigger an update of the virtual sensor as necessary.

The anomaly detection model may utilize an ANN based on an autoencoder to train normal data patterns. An autoencoder is a neural network with an encoder and decoder structure that includes a plurality of layers and may compress (encode) input data (x: a water temperature of a water tank and a pH) into a low-dimensional feature space and then restore (decode) the compressed input data to the same dimension as original data.

The anomaly detection model may calculate a residual on the basis of a similarity between the restored data (x’: a water temperature’ of the water tank and a pH’) generated through the autoencoder and the original data, and when the calculated residual exceeds a preset threshold value, trigger an update of the virtual sensor. The processor 240 may update the virtual sensor according to the trigger of the anomaly detection model.

This means that the virtual sensor needs to be retrained to match new data patterns as environmental conditions change. This mechanism may ensure that the virtual sensor is continuously optimized and maintains accuracy.

The devices described above may be implemented as hardware components, software components, and/or a combination thereof. For example, the devices and components described in the embodiments may be implemented using one or more general-purpose computers or special-purpose computers, such as a processor, a controller, an arithmetic logic unit (ALU), a digital signal processor (DSP), a microcomputer, a field programmable array (FPA), a programmable logic unit (PLU), a microprocessor, or any other device capable of executing instructions and responding to the instructions. Processing devices may execute an operating system (OS) and execute one or more software applications running on the OS. Further, the processing devices may access, store, manipulate, process, and generate data in response to the execution of the software. It can be seen by those skilled in the art that for the ease of understanding, it is described that one processing device is used, but the processing devices may include a plurality of processing elements or a plurality of types of processing elements. For example, the processing device may include a plurality of processors or include a single processor and a single controller. Further, the processing device may also have another processing configuration, such as a parallel processor.

Software may include computer programs, code, instructions, or a combination of one or more of these, and may configure a processing device to perform a desired operation or, independently or collectively, command the processing device. Software and/or data may be stored in storage media, such as a memory and the like, for being interpreted by the processing device or for providing instructions or data to the processing device.

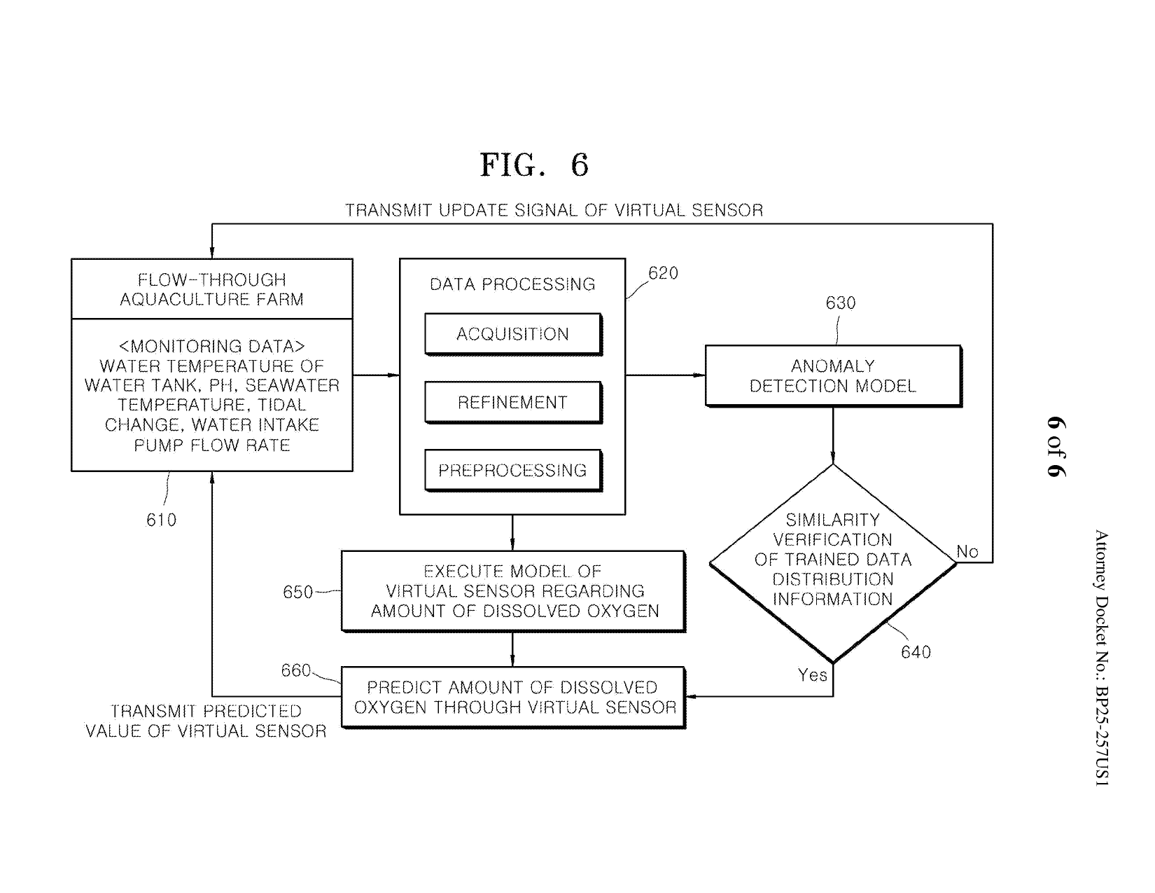

FIG. 6 is a flowchart for describing a virtual sensor performance monitoring method according to an embodiment of the present invention.

The virtual sensor performance monitoring method described herein is only one embodiment of the present invention, and in addition, various operations may be added as needed, as illustrated below, the operations below may also be performed in a different order, and thus the present invention is not limited to the operations and their order described below.

Referring to FIGS. 2 and 6, in operation 610, the processor 240 may measure monitoring data, that is, aquaculture farm environment data such as a water temperature of a water tank, a pH, a seawater temperature, a tidal change, a water intake pump flow rate, etc., in a flow-through aquaculture farm through the sensors 210.

Next, in operation 620, the processor 240 may obtain the monitoring data, refine and preprocess the obtained monitoring data, and convert the refined and preprocessed monitoring data into data of a format suitable for an anomaly detection model.

Next, in operation 630, the processor 240 may predict an amount of dissolved oxygen in an aquaculture farm using the anomaly detection model.

Next, in operation 640, the processor 240 may verify a similarity of distribution information of data trained through the anomaly detection model. That is, the processor 240 may calculate a residual between the data predicted through the anomaly detection model and actual data.

Next, in operation 650, the processor 240 may execute a model of a virtual sensor regarding the amount of dissolved oxygen according to a result of the similarity verification, and in operation 660, the processor 240 may predict the amount of dissolved oxygen through the virtual sensor.

That is, when the residual between the data predicted through the anomaly detection model and the actual data exceeds a preset threshold value (“Yes” direction of operation 640), the processor 240 may trigger an update of the virtual sensor through the anomaly detection model.

Accordingly, the processor 240 may transmit an update signal of the virtual sensor to update the virtual sensor. This means that the virtual sensor needs to be retrained to match the changed environmental conditions of the aquaculture farm.

On the other hand, when the residual between the data predicted through the anomaly detection model and the actual data does not exceed the preset threshold value (“No” direction of operation 640), the processor 240 may transmit a predicted value of the virtual sensor. That is, the processor 240 may determine that there is no need to update the virtual sensor, and transmit the predicted value of the virtual sensor to the user terminal 110.

According to the present invention, by updating a virtual sensor to match an environment of a flow-through aquaculture farm, it is possible to accurately predict an amount of dissolved oxygen in a water tank of the flow-through aquaculture farm.

According to the present invention, by continuously monitoring the accuracy of a virtual sensor and updating a model as needed, it is possible to maximize the operational efficiency of an aquaculture farm and improve fish survival rates.

According to the present invention, by utilizing a virtual sensor and an anomaly detection model that predict an amount of dissolved oxygen by integrating various types of environmental data, such as a seawater temperature, a tidal change, a water intake pump flow rate, a water temperature of a water tank, and a pH, in a flow-through aquaculture farm, it is possible to accurately monitor an amount of dissolved oxygen in a water tank in real time, and thus the present invention can significantly contribute to improving essential water quality management in the aquaculture farm and maintaining fish health.

While the present invention has been described with reference to embodiments illustrated in the accompanying drawings, the embodiments should be considered in a descriptive sense only, and it should be understood by those skilled in the art that various alterations and other equivalent embodiments may be made. Therefore, the scope of the present invention should be defined by only the following claims.

What is claimed is:

1. A virtual sensor performance monitoring device comprising:
a sensor; and
a processor configured to monitor performance of a virtual sensor that predicts an amount of dissolved oxygen in an aquaculture farm on the basis of aquaculture farm environment data collected through the sensor.

2. The virtual sensor performance monitoring device of claim 1, wherein the processor monitors performance of the virtual sensor using an anomaly detection model of the virtual sensor.

3. The virtual sensor performance monitoring device of claim 2, wherein the anomaly detection model uses the aquaculture farm environment data to predict the amount of dissolved oxygen in the aquaculture farm, and
the processor monitors the performance of the virtual sensor on the basis of a predicted value of the amount of dissolved oxygen.

4. The virtual sensor performance monitoring device of claim 2, wherein the processor updates the virtual sensor on the basis of a result of monitoring the performance of the virtual sensor.

5. The virtual sensor performance monitoring device of claim 2, wherein the processor compares a predicted value of the amount of dissolved oxygen with an actual value to calculate a residual between the predicted value and the actual value, and when the residual exceeds a preset threshold value, updates the virtual sensor.

6. The virtual sensor performance monitoring device of claim 5, wherein the anomaly detection model obtains the predicted value of the amount of dissolved oxygen using an artificial neural network based on an autoencoder that uses the aquaculture farm environment data as an input, and
when the input data is compressed into a low-dimensional feature space through the autoencoder and then restored to the same dimension as original data to generate restored data, the processor calculates the residual on the basis of a similarity between the restored data and the original data, and when the residual exceeds the threshold value, updates the virtual sensor.

7. The virtual sensor performance monitoring device of claim 1, wherein the aquaculture farm environment data includes at least one piece of data among a water temperature of a water tank, pH, a seawater temperature, a tidal change, and a water intake pump flow rate.

8. The virtual sensor performance monitoring device of claim 1, wherein the virtual sensor is a model of an artificial neural network structure including an input layer that receives the aquaculture farm environment data as input data, at least one hidden layer, and an output layer that outputs a result, and adjusts a weight of each layer through a training process to predict the amount of dissolved oxygen from the input data.

9. A virtual sensor performance monitoring method comprising:
collecting, by a processor, aquaculture farm environment data through a sensor; and
monitoring, by the processor, performance of a virtual sensor that predicts an amount of dissolved oxygen in an aquaculture farm on the basis of the collected aquaculture farm environment data.

10. The virtual sensor performance monitoring method of claim 9, wherein the monitoring of the performance of the virtual sensor includes monitoring the performance of the virtual sensor using an anomaly detection model of the virtual sensor.

11. The virtual sensor performance monitoring method of claim 10, wherein the anomaly detection model uses the aquaculture farm environment data to predict the amount of dissolved oxygen in the aquaculture farm, and
the monitoring of the performance of the virtual sensor includes monitoring the performance of the virtual sensor on the basis of a predicted value of the amount of dissolved oxygen.

12. The virtual sensor performance monitoring method of claim 10, further comprising updating, by the processor, the virtual sensor on the basis of a result of monitoring the performance of the virtual sensor.

13. The virtual sensor performance monitoring method of claim 12, wherein the updating of the virtual sensor includes:
comparing a predicted value of the amount of dissolved oxygen with an actual value and calculating a residual between the predicted value and the actual value; and
when the residual exceeds a preset threshold value, updating the virtual sensor.

14. The virtual sensor performance monitoring method of claim 13, wherein the anomaly detection model obtains the predicted value of the amount of dissolved oxygen using an artificial neural network based on an autoencoder that uses the aquaculture farm environment data as an input, and
the updating of the virtual sensor includes:
when the input data is compressed into a low-dimensional feature space through the autoencoder and then restored to the same dimension as original data to generate restored data, calculating the residual on the basis of a similarity between the restored data and the original data; and
when the residual exceeds the threshold value, updating the virtual sensor.

15. The virtual sensor performance monitoring method of claim 9, wherein the aquaculture farm environment data includes at least one piece of data among a water temperature of a water tank, pH, a seawater temperature, a tidal change, and a water intake pump flow rate.

16. The virtual sensor performance monitoring method of claim 9, wherein the virtual sensor is a model of an artificial neural network structure including an input layer that receives the aquaculture farm environment data as input data, at least one hidden layer, and an output layer that outputs a result, and adjusts a weight of each layer through a training process to predict the amount of dissolved oxygen from the input data.
